(19) United States
(12) Patent Application Publication
(10) Pub. No.: US 2020/0068556 A1
(43) Pub. Date: Feb. 27, 2020

(54) COMMUNICATION SYSTEM

(71) Applicant: NOKIA TECHNOLOGIES OY, Espoo (FI)

(72) Inventors: Esa Tapani Tiirola, Kempele (FI); Kari Juhani Hooli, Oulu (FI); Kari Pekka Pajukoski, Oulu (FI); Timo Erkki Lunttila, Espoo (FI)

(73) Assignee: Nokia Technologies Oy, Espoo (FI)

(21) Appl. No.: 16/346,301

(22) PCT Filed: Nov. 3, 2016
(86) PCT No.: PCT/EP2016/076606

§ 371 Date: Apr. 30, 2019

(51) Int. Cl. H04W 72/04; H04W 16/02; H04L 5/00; H04W 72/12

(52) U.S. Cl. CPC H04W 72/0413; H04W 16/02; H04W 72/044; H04W 72/1284; H04L 5/0007

(57) ABSTRACT

There is provided a method comprising: transmitting, by an apparatus, an indication of a plurality of resource elements for uplink transmissions of uplink control information and uplink data; and receiving, by the apparatus, uplink control information on a portion of said plurality of resource elements, the portion being defined by a mapping operation, wherein said mapping operation comprises: partitioning the plurality of resource elements to define a predetermined number of frequency domain resource element sets; and mapping the uplink control information to the plurality of resource elements in the predetermined number of frequency domain resource element sets to identify the portion of the plurality of resource elements.

### FIELD OF THE INVENTION

This disclosure relates to a method and apparatus, and in particular but not exclusively to a method and apparatus relating to transmitting uplink control information.

### BACKGROUND

A communication system can be seen as a facility that enables communication between two or more devices such as user terminals, machine-like terminals, base stations and/or other nodes by providing carriers between the communication devices. A communication system can be provided for example by means of a communication network and one or more compatible communication devices. The communication may comprise, for example, communication of data for carrying communications such as voice, electronic mail (email), text message, multimedia and/or content data and so on. Non-limiting examples of services provided include two-way or multi-way calls, data communication or multimedia services and access to a data network system, such as the Internet.

In a wireless system at least a part of communications between at least two stations occurs over wireless interfaces. Examples of wireless systems include public land mobile networks (PLMN), satellite based communication systems and different wireless local networks, for example wireless local area networks (WLAN). A local area wireless networking technology allowing devices to connect to a data network is known by the tradename Wi-Fi (or WiFi). Wi-Fi is often used synonymously with WLAN.

The wireless systems can be divided into cells, and are therefore often referred to as cellular systems. A user can access a communication system by means of an appropriate communication device or terminal. A communication device of a user is often referred to as user equipment (UE) or user apparatus. A communication device is provided with an appropriate signal receiving and transmitting apparatus for enabling communications, for example enabling access to a communication network or communications directly with other users. The communication device may access a carrier provided by a station, for example a base station of a cell, and transmit and/or receive communications on the carrier.

A communication system and associated devices typically operate in accordance with a given standard or specification which sets out what the various entities associated with the system are permitted to do and how that should be achieved. Communication protocols and/or parameters which shall be used for the connection are also typically defined. An example of standardized communication system architectures is the long-term evolution (LTE) of the Universal Mobile Telecommunications System (UMTS) radio-access technology. The LTE is being standardized by the 3rd Generation Partnership Project (3GPP). The LTE employs the Evolved Universal Terrestrial Radio Access Network (E-UTRAN) access. Further development of LTE are sometimes referred to as LTE Advanced (LTE-A). The various development stages of 3GPP specifications are referred to as releases. In this description 3GPP release versions are distinguished by acronym “Rel-nn”.

In addition to LTE evolution, 3GPP has initiated a study item targeting a new radio generation (5G) called new radio (NR). NR does not require backwards compatibility with LTE. Instead, it aims at tight interworking between the RAT (radio access technology) and LTE. An objective of a NR study item is to identify and develop technology components needed for new radio (NR) systems to use any spectrum band ranging at least up to 100 GHz. The aim may be to achieve a single technical framework addressing usage scenarios, requirements and deployment scenarios defined in, for example, TR 38.913. The new radio access technology may be forward compatible to allow specification in two separate phases (Phase I and Phase II).

### SUMMARY

According to a first aspect, there is provided a method comprising: transmitting, by an apparatus, an indication of a plurality of resource elements for uplink transmissions of uplink control information and uplink data; and receiving, by the apparatus, uplink control information on a portion of said plurality of resource elements, the portion being defined by a mapping operation, wherein said mapping operation comprises: partitioning the plurality of resource elements to define a predetermined number of frequency domain resource element sets; and mapping the uplink control information to the plurality of resource elements in the predetermined number of frequency domain resource element sets to identify the portion of the plurality of resource elements.

The method may further comprise: determining a number of resource elements required for transmitting the uplink control information in dependence on a power difference between a resource element assigned for uplink data transmission and a resource element assigned for uplink control information transmission.

The method may further comprise transmitting an indication of a power difference between a resource element assigned for uplink data transmission and a resource element assigned for uplink control information transmission to the another apparatus.

The method may further comprise receiving the uplink control information based on at least one of a cyclic-prefix orthogonal frequency division multiple access scheme and/or a discrete Fourier transform-spread-orthogonal frequency division multiple access scheme.

Said uplink control information may comprise first and second types of uplink control information, and wherein said mapping operation further comprises: mapping the first type of uplink control information only to resource elements in a first frequency domain resource element set of the predetermined number of frequency domain resource element sets; and mapping the second type of uplink control information only to resource elements in a second frequency domain resource element set of the predetermined number of frequency domain resource element sets.

Said uplink control information may comprise first and second types of uplink control information, wherein said mapping operation further comprises: mapping the first type of uplink control information only to resource elements in a first frequency domain resource element set of the predetermined number of frequency domain resource element sets; and mapping some of the second type of uplink control information to resource elements in the first frequency domain resource element set and some of the second type of uplink control information to resource elements in a second frequency domain resource element set of the predetermined number of frequency domain resource element sets.

Said uplink control information may comprise first and second types of uplink control information, wherein said mapping operation further comprises: mapping some of the first type of uplink control information to a first frequency domain resource element set of the predetermined number of frequency domain resource element sets and some of the first type of uplink control information to a second frequency domain resource element set of the predetermined number of frequency domain resource element sets; and mapping some of the second type of uplink control information to the first frequency domain resource element set and some of the second type of uplink control information to the second frequency domain resource element set.

Said plurality of resource elements may all be located on an uplink shared channel.

The method may further comprise determining the predetermined number of frequency domain resource element sets. The method may further comprise determining the predetermined number of frequency domain resource element sets in dependence of at least one of: current uplink transmission conditions, and/or radio channel characteristic and/or service type.

Said uplink control information may comprise first and second types of uplink control information, the first type of uplink control information being more time critical than the second type of uplink control information and the method may further comprise: mapping said first and second types of uplink control information such that the first type of uplink control information is transmitted before the second type of uplink control information. The second type of uplink control information may be transmitted in the last unit time period of a particular scheduling unit whilst the first type of uplink control information is transmitted in the earliest available unit time period of the scheduling unit. The first type of uplink control information may be at least one of an acknowledgement feedback and/or a rank indicator and/or a beam index, and wherein the second type of uplink control information may be at least one of a channel quality indicator and a precoding matrix indicator.

According to a second aspect, there is provided a method comprising: receiving, by an apparatus, an indication of a plurality of resource elements for uplink transmissions of uplink control information and uplink data; and transmitting, by the apparatus, uplink control information on a portion of said plurality of resource elements, said portion being identified via a mapping operation, wherein said mapping operation comprises: partitioning the plurality of resource elements to define a predetermined number of frequency domain resource element sets; and mapping the uplink control information to the plurality of resource elements in the predetermined number of frequency domain resource element sets to identify the portion of the plurality of resource elements.

The method may further comprise: receiving, by the apparatus, an indication to use the portion of said plurality of resource elements for transmission of uplink control information. Said indication may be a trigger message. The method may further comprise mapping the uplink data transmissions around the uplink control information.

The method may further comprise: determining a number of resource elements required for transmitting the uplink control information in dependence on a power difference between a resource element assigned for uplink data transmission and a resource element assigned for uplink control information transmission.

The method may further comprise receiving an indication of a power difference between a resource element assigned for uplink data transmission and a resource element assigned for uplink control information transmission from another apparatus.

The method may further comprise transmitting the uplink control information based on at least one of a cyclic-prefix orthogonal frequency division multiple access scheme and/or a discrete Fourier transform-spread-orthogonal frequency division multiple access scheme.

Said uplink control information may comprise first and second types of uplink control information, wherein said mapping operation further comprises: mapping the first type of uplink control information only to resource elements in a first frequency domain resource element set of the predetermined number of frequency domain resource element sets; and mapping the second type of uplink control information only to resource elements in a second frequency domain resource element set of the predetermined number of frequency domain resource element sets.

Said uplink control information may comprise first and second types of uplink control information, wherein said mapping operation further comprises: mapping the first type of uplink control information only to resource elements in a first frequency domain resource element set of the predetermined number of frequency domain resource element sets; and mapping some of the second type of uplink control information to resource elements in the first frequency domain resource element set and some of the second type of uplink control information to resource elements in a second frequency domain resource element set of the predetermined number of frequency domain resource element sets.

Said uplink control information may comprise first and second types of uplink control information, wherein said mapping operation further comprises: mapping some of the first type of uplink control information to a first frequency domain resource element set of the predetermined number of frequency domain resource element sets and some of the first type of uplink control information to a second frequency domain resource element set of the predetermined number of frequency domain resource element sets; and mapping some of the second type of uplink control information to the first frequency domain resource element set and some of the second type of uplink control information to the second frequency domain resource element set.

Said plurality of resource elements may all be located on an uplink shared channel.

The method may further comprise determining the predetermined number of frequency domain resource element sets. The method may further comprise determining the predetermined number of frequency domain resource element sets in dependence of at least one of: current uplink transmission conditions, and/or radio channel characteristic and/or service type.

Said uplink control information may comprise first and second types of uplink control information, the first type of uplink control information being more time critical than the second type of uplink control information and the method may further comprise: mapping said first and second types of uplink control information such that the first type of uplink control information is transmitted before the second type of uplink control information. The second type of uplink control information may be transmitted in the last unit time period of a particular scheduling unit whilst the first type of uplink control information is transmitted in the earliest available unit time period of the scheduling unit. The first type of uplink control information may be at least one of an acknowledgement feedback and/or a rank indicator and/or a beam index, and wherein the second type of uplink control information may be at least one of a channel quality indicator and a precoding matrix indicator.

Said uplink control information may comprise first and second types of uplink control information, and the method may further comprise: mapping said first and second types of uplink control information into the predetermined number of frequency domain resource element sets independently of each other.

Said uplink control information may comprise first and second types of uplink control information, and the method may further comprise: jointly encoding the first and second types of uplink control information prior to performing any mapping information.

The method may further comprise: determining a number of resource elements required for transmitting the uplink control information; and performing said identifying only if the number of resource elements is larger than a threshold value. Said threshold value may correspond to a number of resource elements available on an uplink control channel.

According to a third aspect, there is provided an apparatus comprising: means for transmitting an indication of a plurality of resource elements for uplink transmissions of uplink control information and uplink data; and means for receiving uplink control information on a portion of said plurality of resource elements, the portion being defined by a mapping operation, wherein said mapping operation comprises: partitioning the plurality of resource elements to define a predetermined number of frequency domain resource element sets; and mapping the uplink control information to the plurality of resource elements in the predetermined number of frequency domain resource element sets to identify the portion of the plurality of resource elements.

The apparatus may further comprise: means for determining a number of resource elements required for transmitting the uplink control information in dependence on a power difference between a resource element assigned for uplink data transmission and a resource element assigned for uplink control information transmission.

The apparatus may further comprise means for transmitting an indication of a power difference between a resource element assigned for uplink data transmission and a resource element assigned for uplink control information transmission to the another apparatus.

The apparatus may further comprise means for receiving the uplink control information based on at least one of a cyclic-prefix orthogonal frequency division multiple access scheme and/or a discrete Fourier transform-spread-orthogonal frequency division multiple access scheme.

Said uplink control information may comprise first and second types of uplink control information, wherein said mapping operation further comprises: mapping the first type of uplink control information only to resource elements in a first frequency domain resource element set of the predetermined number of frequency domain resource element sets; and mapping the second type of uplink control information only to resource elements in a second frequency domain resource element set of the predetermined number of frequency domain resource element sets.

Said uplink control information may comprise first and second types of uplink control information, wherein said mapping operation further comprises: mapping the first type of uplink control information only to resource elements in a first frequency domain resource element set of the predetermined number of frequency domain resource element sets; and mapping some of the second type of uplink control information to resource elements in the first frequency domain resource element set and some of the second type of uplink control information to resource elements in a second frequency domain resource element set of the predetermined number of frequency domain resource element sets.

Said uplink control information may comprise first and second types of uplink control information, wherein said mapping operation further comprises: mapping some of the first type of uplink control information to a first frequency domain resource element set of the predetermined number of frequency domain resource element sets and some of the first type of uplink control information to a second frequency domain resource element set of the predetermined number of frequency domain resource element sets; and mapping some of the second type of uplink control information to the first frequency domain resource element set and some of the second type of uplink control information to the second frequency domain resource element set.

Said plurality of resource elements may all be located on an uplink shared channel.

The apparatus may further comprise means for determining the predetermined number of frequency domain resource element sets. The apparatus may further comprise means for determining the predetermined number of frequency domain resource element sets in dependence of at least one of: current uplink transmission conditions, and/or radio channel characteristic and/or service type.

Said uplink control information may comprise first and second types of uplink control information, the first type of uplink control information being more time critical than the second type of uplink control information and the apparatus may further comprise: means for mapping said first and second types of uplink control information such that the first type of uplink control information is transmitted before the second type of uplink control information. The second type of uplink control information may be transmitted in the last unit time period of a particular scheduling unit whilst the first type of uplink control information is transmitted in the earliest available unit time period of the scheduling unit. The first type of uplink control information may be at least one of an acknowledgement feedback and/or a rank indicator and/or a beam index, and wherein the second type of uplink control information may be at least one of a channel quality indicator and a precoding matrix indicator.

According to a fourth aspect, there is provided an apparatus comprising: means for receiving an indication of a plurality of resource elements for uplink transmissions of uplink control information and uplink data; and means for transmitting uplink control information on a portion of said plurality of resource elements, said portion being identified via a mapping operation, wherein said mapping operation comprises: partitioning the plurality of resource elements to define a predetermined number of frequency domain resource element sets; and mapping the uplink control information to the plurality of resource elements in the predetermined number of frequency domain resource element sets to identify the portion of the plurality of resource elements.

The apparatus may further comprise: means for receiving an indication to use the portion of said plurality of resource elements for transmission of uplink control information. Said indication may be a trigger message. The apparatus may further comprise means for mapping the uplink data transmissions around the uplink control information.

The apparatus may further comprise: means for determining a number of resource elements required for transmitting the uplink control information in dependence on a power difference between a resource element assigned for uplink data transmission and a resource element assigned for uplink control information transmission.

The apparatus may further comprise means for receiving an indication of a power difference between a resource element assigned for uplink data transmission and a resource element assigned for uplink control information transmission from another apparatus.

The apparatus may further comprise means for transmitting the uplink control information based on at least one of a cyclic-prefix orthogonal frequency division multiple access scheme and/or a discrete Fourier transform-spread-orthogonal frequency division multiple access scheme.

Said uplink control information may comprise first and second types of uplink control information, wherein said mapping operation further comprises: mapping the first type of uplink control information only to resource elements in a first frequency domain resource element set of the predetermined number of frequency domain resource element sets; and mapping the second type of uplink control information only to resource elements in a second frequency domain resource element set of the predetermined number of frequency domain resource element sets.

Said uplink control information may comprise first and second types of uplink control information, wherein said mapping operation further comprises: mapping the first type of uplink control information only to resource elements in a first frequency domain resource element set of the predetermined number of frequency domain resource element sets; and mapping some of the second type of uplink control information to resource elements in the first frequency domain resource element set and some of the second type of uplink control information to resource elements in a second frequency domain resource element set of the predetermined number of frequency domain resource element sets.

Said uplink control information may comprise first and second types of uplink control information, wherein said mapping operation further comprises: mapping some of the first type of uplink control information to a first frequency domain resource element set of the predetermined number of frequency domain resource element sets and some of the first type of uplink control information to a second frequency domain resource element set of the predetermined number of frequency domain resource element sets; and mapping some of the second type of uplink control information to the first frequency domain resource element set and some of the second type of uplink control information to the second frequency domain resource element set.

Said plurality of resource elements may all be located on an uplink shared channel.

The apparatus may further comprise means for determining the predetermined number of frequency domain resource element sets. The apparatus may further comprise means for determining the predetermined number of frequency domain resource element sets in dependence of at least one of: current uplink transmission conditions, and/or radio channel characteristic and/or service type.

Said uplink control information may comprise first and second types of uplink control information, the first type of uplink control information being more time critical than the second type of uplink control information and the apparatus may further comprise: means for mapping said first and second types of uplink control information such that the first type of uplink control information is transmitted before the second type of uplink control information. The second type of uplink control information may be transmitted in the last unit time period of a particular scheduling unit whilst the first type of uplink control information is transmitted in the earliest available unit time period of the scheduling unit. The first type of uplink control information may be at least one of an acknowledgement feedback and/or a rank indicator and/or a beam index, and wherein the second type of uplink control information may be at least one of a channel quality indicator and a precoding matrix indicator.

According to a fifth aspect, there is provided an apparatus at least one processor; and at least one memory comprising code that, when executed on said at least one processor, causes the apparatus to: transmit an indication of a plurality of resource elements for uplink transmissions of uplink control information and uplink data; and receive uplink control information on a portion of said plurality of resource elements, the portion being defined by a mapping operation, wherein said mapping operation comprises: partitioning the plurality of resource elements to define a predetermined number of frequency domain resource element sets; and map the uplink control information to the plurality of resource elements in the predetermined number of frequency domain resource element sets to identify the portion of the plurality of resource elements.

The apparatus may further be caused to: determine a number of resource elements required for transmitting the uplink control information in dependence on a power difference between a resource element assigned for uplink data transmission and a resource element assigned for uplink control information transmission.

The apparatus may further be caused to transmit an indication of a power difference between a resource element assigned for uplink data transmission and a resource element assigned for uplink control information transmission to the another apparatus.

The apparatus may further be caused to receive the uplink control information based on at least one of a cyclic-prefix orthogonal frequency division multiple access scheme and/or a discrete Fourier transform-spread-orthogonal frequency division multiple access scheme.

Said uplink control information may comprise first and second types of uplink control information, wherein said mapping operation further comprises: mapping the first type of uplink control information only to resource elements in a first frequency domain resource element set of the predetermined number of frequency domain resource element sets; and mapping the second type of uplink control information only to resource elements in a second frequency domain resource element set of the predetermined number of frequency domain resource element sets.

Said uplink control information may comprise first and second types of uplink control information, wherein said mapping operation further comprises: mapping the first type of uplink control information only to resource elements in a first frequency domain resource element set of the predetermined number of frequency domain resource element sets; and mapping some of the second type of uplink control information to resource elements in the first frequency domain resource element set and some of the second type of uplink control information to resource elements in a second frequency domain resource element set of the predetermined number of frequency domain resource element sets.

Said uplink control information may comprise first and second types of uplink control information, wherein said mapping operation further comprises: mapping some of the first type of uplink control information to a first frequency domain resource element set of the predetermined number of frequency domain resource element sets and some of the first type of uplink control information to a second frequency domain resource element set of the predetermined number of frequency domain resource element sets; and mapping some of the second type of uplink control information to the first frequency domain resource element set and some of the second type of uplink control information to the second frequency domain resource element set.

Said plurality of resource elements may all be located on an uplink shared channel.

The apparatus may further be caused to determine the predetermined number of frequency domain resource element sets. The apparatus may further comprise means for determining the predetermined number of frequency domain resource element sets in dependence of at least one of: current uplink transmission conditions, and/or radio channel characteristic and/or service type.

Said uplink control information may comprise first and second types of uplink control information, the first type of uplink control information being more time critical than the second type of uplink control information and the apparatus may further be caused to map said first and second types of uplink control information such that the first type of uplink control information is transmitted before the second type of uplink control information. The second type of uplink control information may be transmitted in the last unit time period of a particular scheduling unit whilst the first type of uplink control information is transmitted in the earliest available unit time period of the scheduling unit. The first type of uplink control information may be at least one of an acknowledgement feedback and/or a rank indicator and/or a beam index, and wherein the second type of uplink control information may be at least one of a channel quality indicator and a precoding matrix indicator.

According to a sixth aspect, there is provided an apparatus at least one processor; and at least one memory comprising code that, when executed on said at least one processor, causes the apparatus to: receive an indication of a plurality of resource elements for uplink transmissions of uplink control information and uplink data; and means for transmitting uplink control information on a portion of said plurality of resource elements, said portion being identified via a mapping operation, wherein said mapping operation comprises: partitioning the plurality of resource elements to define a predetermined number of frequency domain resource element sets; and mapping the uplink control information to the plurality of resource elements in the predetermined number of frequency domain resource element sets to identify the portion of the plurality of resource elements.

The apparatus may further be caused to receive an indication to use the portion of said plurality of resource elements for transmission of uplink control information. Said indication may be a trigger message. The apparatus may further be caused to map the uplink data transmissions around the uplink control information.

The apparatus may further be caused to determine a number of resource elements required for transmitting the uplink control information in dependence on a power difference between a resource element assigned for uplink data transmission and a resource element assigned for uplink control information transmission.

The apparatus may further be caused to receive an indication of a power difference between a resource element assigned for uplink data transmission and a resource element assigned for uplink control information transmission from another apparatus.

The apparatus may be further caused to transmit the uplink control information based on at least one of a cyclic-prefix orthogonal frequency division multiple access scheme and/or a discrete Fourier transform-spread-orthogonal frequency division multiple access scheme.

Said uplink control information may comprise first and second types of uplink control information, wherein said mapping operation further comprises: mapping the first type of uplink control information only to resource elements in a first frequency domain resource element set of the predetermined number of frequency domain resource element sets; and mapping the second type of uplink control information only to resource elements in a second frequency domain resource element set of the predetermined number of frequency domain resource element sets.

Said uplink control information may comprise first and second types of uplink control information, wherein said mapping operation further comprises: mapping the first type of uplink control information only to resource elements in a first frequency domain resource element set of the predetermined number of frequency domain resource element sets; and mapping some of the second type of uplink control information to resource elements in the first frequency domain resource element set and some of the second type of uplink control information to resource elements in a second frequency domain resource element set of the predetermined number of frequency domain resource element sets.

Said uplink control information may comprise first and second types of uplink control information, wherein said mapping operation further comprises: mapping some of the first type of uplink control information to a first frequency domain resource element set of the predetermined number of frequency domain resource element sets and some of the first type of uplink control information to a second frequency domain resource element set of the predetermined number of frequency domain resource element sets; and mapping some of the second type of uplink control information to the first frequency domain resource element set and some of the second type of uplink control information to the second frequency domain resource element set.

Said plurality of resource elements may all be located on an uplink shared channel.

The apparatus may further be caused to determine the predetermined number of frequency domain resource element sets. The apparatus may further comprise means for determining the predetermined number of frequency domain resource element sets in dependence of at least one of: current uplink transmission conditions, and/or radio channel characteristic and/or service type.

Said uplink control information may comprise first and second types of uplink control information, the first type of uplink control information being more time critical than the second type of uplink control information and the apparatus may further be caused to map said first and second types of uplink control information such that the first type of uplink control information is transmitted before the second type of uplink control information. The second type of uplink control information may be transmitted in the last unit time period of a particular scheduling unit whilst the first type of uplink control information is transmitted in the earliest available unit time period of the scheduling unit. The first type of uplink control information may be at least one of an acknowledgement feedback and/or a rank indicator and/or a beam index, and wherein the second type of uplink control information may be at least one of a channel quality indicator and a precoding matrix indicator.

There is further provided an apparatus comprising: at least one processor; and at least one memory comprising code that, when executed on said at least one processor, causes the apparatus to perform the steps of any of claims 1 and 3 to 20 when dependent on claim 1.

There is further provided an apparatus comprising: at least one processor; and at least one memory comprising code that, when executed on said at least one processor, causes the apparatus to perform the steps of any of claims 2 and 3 to 20 when dependent on claim 2.

There is further provided a computer program comprising computer code that, when executed on at least one processor, causes the method of any of claims 1 and 3 to 20 when dependent on claim 1, or any of claims 2 and 3 to 20 when dependent on claim 2.

Thus a computer program comprising program code means adapted to perform the herein described methods may also be provided. In accordance with further embodiments apparatus and/or computer program product that can be embodied on a non transitory computer readable medium for providing at least one of the above methods is provided.

It should be appreciated that any feature of any aspect may be combined with any other feature of any other aspect.

Various other aspects and further embodiments are also described in the following detailed description of examples embodying the invention and in the attached claims.

### FIGURES

Some embodiments will now be described in further detail, by way of example only, with reference to the following examples and accompanying drawings, in which:

FIG. 1 shows a schematic example of a system where the invention may be implemented;

FIG. 2 shows an example of a communication device;

FIG. 3 illustrates types of uplink and downlink slot structures;

FIG. 4 illustrates different mechanisms for transmitting uplink control information;

FIG. 5 illustrates potential use of resources for transmitting uplink control information;

FIG. 6 is a flow chart illustrating potential actions performed by an apparatus;

FIGS. 7 to 10 illustrate potential mapping operations; and

FIG. 11 is a flow chart illustrating potential actions performed by an apparatus.

### DETAILED DESCRIPTION

In general, the following disclosure relates to a mapping operation and use thereof for identifying and/or designating uplink resources to be used for the transmission of uplink control information. Uplink control information includes channel state information, such as rank indicator, precoding matrix identifier and channel quality indicator, as well as feedback regarding data received on the downlink (e.g. ACK/NACK for a hybrid automatic repeat request (HARQ) procedure, also referred to herein as HARQ-ACK).

In particular, the following aims to increase the frequency diversity for making transmissions of uplink control information, particularly when at least some of the uplink control information is to be transmitted on the uplink shared channel resources. To effect this, the uplink control information is mapped onto particular resource elements in the uplink shared channel for transmission by partitioning the available resources for this transmission into a plurality of groups (i.e. two or more groups of frequency resources) and mapping the uplink control information to be transmitted into these separate groups. For example, where the available frequencies are split up into two groups, the uplink control information may also be split into two groups (e.g. every other uplink control information symbol may comprise part of one group, and the remaining uplink control information symbols may comprise part of the other group) and independently mapped within their respective frequency groups.

The same mapping operation may be applied independently in each of a user apparatus and a network apparatus communicating with the user apparatus. This may be performed in several ways.

For example, the network apparatus may determine that uplink control information should be transmitted on the uplink shared channel and transmit a trigger message to the user apparatus indicating this. On receipt of the trigger message, the user apparatus may identify which resource elements of the shared channel the uplink control information should be transmitted on, using the mapping operation, before transmitting on those identified resource elements. The network apparatus may separately apply the mapping operation to determine on which shared channel resource elements the control information will be transmitted. The trigger message may cause the user apparatus to transmit uplink control information on the uplink control channel in addition to on the shared channel. In other words, on receipt of the trigger message, the user apparatus may select between uplink control channel resources and uplink shared channel resources for at least one type of uplink control information.

In an alternative example, on receipt of the trigger message, the user apparatus may not perform such a mapping operation if the trigger message comprises an indication of which resources should be used for such uplink control information transmissions on the uplink shared channel.

In some examples, no trigger message is transmitted from the network apparatus and the user apparatus. Instead, each device is programmed with a set of rules for determining when the uplink control information should be transmitted on the uplink shared channel. These rules are the same (and may be applied independently) in each of the user apparatus and the network apparatus. The rules may relate to current link conditions and/or to a service being provided through the link.

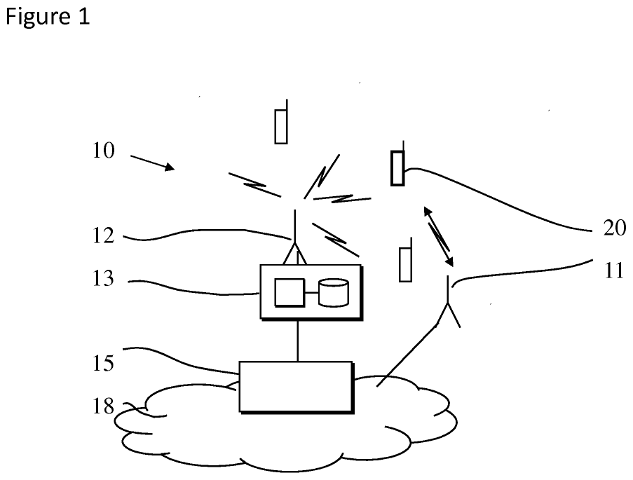

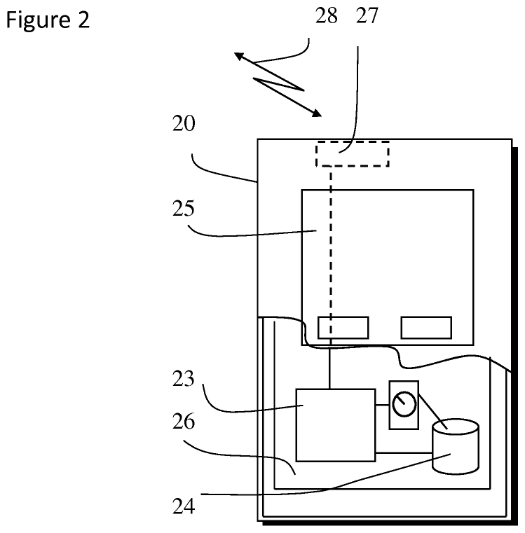

In the following, certain exemplifying embodiments are explained with reference to a wireless communication system serving devices adapted for wireless communication. Therefore, before explaining in detail the exemplifying embodiments, certain general principles of a wireless system, components thereof, and devices for wireless communication are briefly explained with reference to system 10 of FIG. 1, device 20 of FIG. 2 and control apparatus thereof, to assist in understanding the described examples.

A communication device can be used for accessing various services and/or applications provided via a communication system. In wireless communication systems the access is provided via a wireless access interface between wireless communication devices and an appropriate access system. A device may access wirelessly a communication system via a base station. A base station site can provide one or more cells of a cellular system. In the FIG. 1 example, a base station 12 can provide e.g. three cells on different carriers. In addition to the base station 12, at least one serving cell can also be provided by means of another station or stations. For example, at least one of the carriers may be provided by a station that is not co-located at base station 12. This possibility is denoted by station 11 in FIG. 1. Interaction between the different stations and/or controllers thereof can be arranged in various manners. Each communication device 20 and base station may have one or more radio channels open at the same time and may receive signals from more than one source.

A base station may have a control apparatus 13 and/or may be connected to a controller which has the control apparatus. In the latter case, the controller may serve a plurality of base stations.

A base station node can be connected to a data network 18 via an appropriate gateway 15. A gateway function between the access system and another network such as a packet data network may be provided by means of any appropriate gateway node, for example a packet data gateway and/or an access gateway. A communication system may thus be provided by one or more interconnect networks and the elements thereof, and one or more gateway nodes may be provided for interconnecting various networks.

A communication device can access a communication system based on various access techniques, for example those based on the third Generation Partnership Project (3GPP) specifications. A non-limiting example of mobile architectures is known as the Evolved Universal Terrestrial Radio Access Network (E-UTRAN). A non-limiting example of base station of a cellular system is what is termed as a NodeB or enhanced NodeB (eNB) or next generation NodeB (gNB) in the vocabulary of the 3GPP specifications. References in the following to any of these base station types will be considered to also reference at least these other forms of base station. The eNBs may provide E-UTRAN features such as user plane Radio Link Control/Medium Access Control/Physical Layer Protocol (RLC/MAC/PHY) and control plane Radio Resource Control (RRC) protocol terminations towards mobile communication devices.

FIG. 2 shows a schematic, partially sectioned view of a communication device 20 that a user can use for communications. Such a communication device is often referred to as user equipment, user apparatus or terminal. Throughout the following, the term user apparatus will be used. An appropriate communication device may be provided by any device capable of sending and receiving radio signals. Non-limiting examples include a mobile station (MS) such as a mobile phone or what is known as a ‘smart phone’, a portable computer provided with a wireless interface card or other wireless interface facility, personal data assistant (PDA) provided with wireless communication capabilities, or any combinations of these or the like. A mobile communication device may provide, for example, communication of data for carrying communications such as voice, electronic mail (email), text message, multimedia, positioning data, other data, and so on. Users may thus be offered and provided numerous services via their communication devices. Non-limiting examples of these services include two-way or multi-way calls, data communication or multimedia services or simply an access to a data communications network system, such as the Internet.

A communication device is typically provided with at least one data processing entity 23, at least one memory 24 and optionally other possible components for use in software and hardware aided execution of tasks it is designed to perform, including control of access to and communications via base stations and/or other user terminals. The data processing, storage and other relevant control apparatus can be provided on an appropriate circuit board and/or in chipsets and/or in one or more integrated circuits. This apparatus is denoted by reference 26.

Various functions and operations of a communications device are arranged into layers in accordance with a hierarchical model. In the model lower layers report to higher layers and receive instructions therefrom.

A user may control the operation of the device 20 by means of a suitable user interface such as key pad, voice commands, touch sensitive screen or pad, combinations thereof or the like. A display 25, a speaker and a microphone are also typically provided. Furthermore, a mobile communication device may comprise appropriate connectors (either wired or wireless) to other devices and/or for connecting external accessories, for example hands-free equipment, thereto.

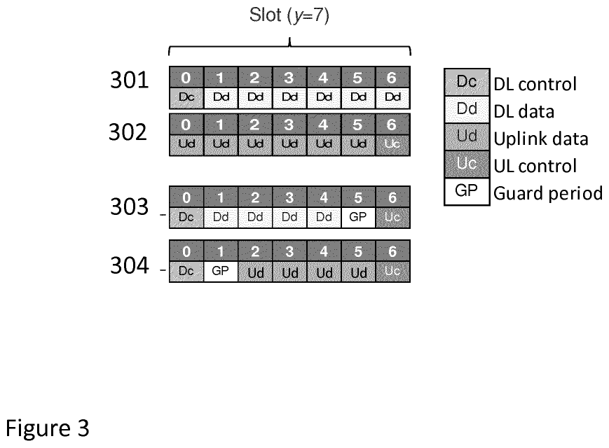

The device 20 may receive and transmit signals 28 via appropriate apparatus for receiving and transmitting signals. In FIG. 2 transceiver apparatus is designated schematically by block 27. The transceiver apparatus may be provided with cognitive radio capability. The transceiver may be provided for example by means of a radio part and associated antenna arrangement. The antenna arrangement may be arranged internally or externally to the mobile device. A wireless communication device can be provided with a Multiple Input/Multiple Output (MIMO) antenna system. In the 5G new radio system, there are four slot types proposed for providing the basic support for both time division duplex and frequency division duplex operation (sometimes it is said that there are only three slot types: an uplink only, a downlink only, and a “special” slot type which comprises mixtures of both uplink and downlink). These proposed slot types are illustrated with respect to FIG. 3. As the definition of slot is not concretely defined in the new radio system at present, it is understood that the term “slot” is used herein to simply denote a time-based unit of transmission, and is thus also used interchangeably with the term “subframe”. Furthermore, discussion related to a shorter scheduling unit, called as “mini-slot” is ongoing in 3GPP. Most likely, new radio will support both slot based transmission and mini-slot-based transmission wherein a mini-slot may comprise of, for example, 1-6 OFDMA (orthogonal frequency division multiple access) symbols whilst a slot comprises 7 or 14 symbols. For discussion purposes only, the following will utilize the resource structure of LTE when describing elements of the proposed system. However, it is understood that this is not limiting the described system to only such a form. For example, LTE has a time domain structure of a radio frame (having a 10 ms length), comprised of 10 subframes (having 1 ms length), each subframe being comprised of two slots (of 0.5 ms length), each slot having 7 OFDM symbols of approximately 71.4 μs length. LTE has a frequency domain structure comprising a large number of subcarriers having a width of approximately 15 kHz, in which a single resource block comprises 12 contiguous subcarriers. A resource element is a combination of the smallest time domain unit and the smallest frequency domain unit (which, in LTE, is an OFDMA symbol or DFT-S-OFDMA in a single subcarrier). The term resource element is not restricted to only LTE technologies. Instead, a functional interpretation may be applied such that the term resource element denotes any combination of the smallest time domain unit and the smallest frequency domain unit in a communication system being considered. New radio may follow a similar definition for the subframe, i.e. the subframe may correspond to a time unit with 1 ms duration. However, the slot length may vary according to a scaling parameter N=2^{k}. In the applied numerology scaling time domain, parameters such as symbol length and cyclic prefix length are scaled down (compared to LTE) by parameter N, whereas subcarrier spacing are scaled up by parameter N.

In FIG. 3, there is shown a “downlink only” slot 301, which comprises an OFDMA symbol of downlink control information and six OFDMA symbols comprising downlink data. There is also shown an “uplink only” slot 302, which comprises an OFDMA symbol of uplink control information and six OFDMA symbols of uplink data. There are also shown two bidirectional slots, “downlink bidirectional” slot 303 and “uplink bidirectional” slot 304, which comprises both uplink and downlink related information. Downlink bidirectional slot 303 comprises an OFDMA symbol of downlink control information, 4 OFDMA symbols of downlink data, an OFDMA symbol of uplink control information and an OFDMA symbol for a guard period, located between the downlink data and the uplink control information. Uplink bidirectional slot 304 comprises an OFDMA symbol of uplink control information, 4 OFDMA symbols of uplink data, an OFDMA symbol of downlink control information and an OFDMA symbol for a guard period, located between the uplink data and the downlink control information.

Bidirectional slots facilitate many time division duplex functionalities in the proposed new radio frame structure, such as link direction switching between downlink and uplink transmissions, providing a fully flexible traffic adaptation between downlink and uplink and providing an opportunity for low latency (when subframe length is selected to be short enough). The bidirectional slots may be looked at as the multiplexing of downlink control information, uplink control information, and a guard period and downlink/uplink data (depending on the slot type). This multiplexing is based on time division multiplexing when possible (this aspect is for future study in the new radio system). Multiplexing in this way enables energy efficient pipeline processing at the receiver, in addition to improved interference mitigation mechanisms for control signals for flexible time division duplex.

The uplink only and downlink only slots are useful in both a frequency division duplex operation and some time division duplex operating examples. For example, some time division duplex operating scenarios allow longer transmission periods in the same direction (e.g. an extended sequence of uplink only or downlink only slots). In order to support smooth coverage extension for a user apparatus, it is therefore useful to be able to extend the transmission of data and control channels over multiple slots.

One of the challenges in the current proposed slot structure for new radio is that uplink control channel coverage may not be sufficient in all situations. For example, in LTE, the physical uplink control channel duration is one millisecond whereas in the current proposed slot types of FIG. 1, the physical uplink control channel duration is just one orthogonal frequency division multiple access (OFDMA) symbol. Usefully, the new radio physical uplink control channel should have comparable uplink coverage with LTE. In order to address these coverage issues, it was agreed in RAN1#86bis to support the frequency division multiplexing of uplink control channel with uplink data channel within a slot.

At least two ways of transmissions are supported for the proposed new radio uplink control channel. First, it is supported that the uplink control channel can be transmitted in short duration. In this case, around the last transmitted uplink symbol(s) of a slot, there is provided a guard period (how to define and treat the potential gap at the end of the slot is for future studies). In the other OFDMA symbol positions, e.g., the first uplink symbol(s) of a slot are time division multiplexed and/or frequency division multiplexed with the uplink data channel within a slot. Secondly, it is supported that the uplink control channel can be transmitted in long duration. In this case, the control channel transmission is made over multiple uplink symbols to improve coverage and the control information is frequency division multiplexed with the uplink data channel within such a slot. It is for future study how to multiplex these types of transmissions with a sounding reference signal. It is understood that if frequency hopping is used, this frequency hopping does not spread over the entire carrier bandwidth.

Similar considerations are also relevant to LTE work on latency reduction, where it is possible to carry uplink control information on 2-symbols of a physical uplink shared channel in an efficient manner.

When using a short physical uplink control channel (e.g. transmitting control information on a single symbol within a slot), multiplexing between uplink control information and uplink data is based on time division multiplexing. Hence, in this case, the slot structure facilitates also the multiplexing (as per the example of FIG. 3).

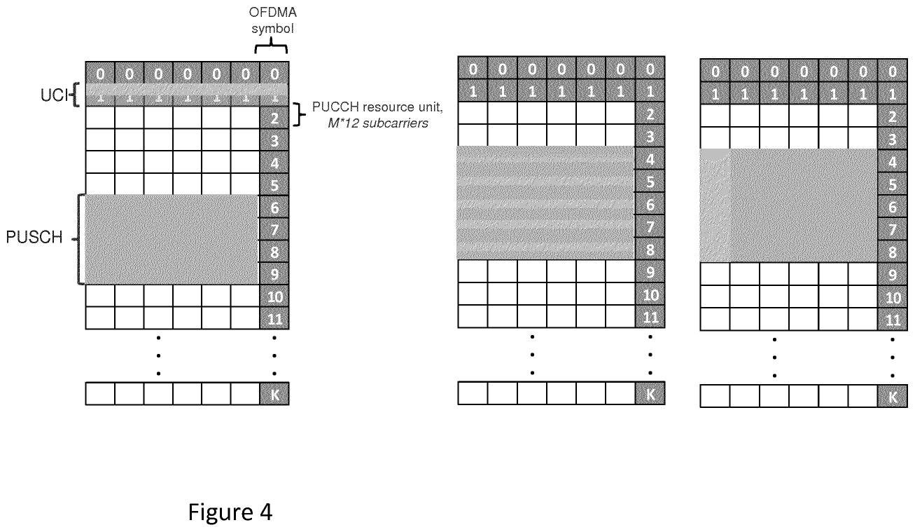

However, in the case when frequency division multiplexing between the physical uplink control channel and the physical uplink shared channel is used, there are two main tracks for effecting the multiplexing of these two channels. This is reflected in FIGS. 4A and 4B.

FIG. 4A illustrates a scenario in which uplink control information is always transmitted on the physical uplink control channel. In this particular example, a single resource unit is assigned for the control channel transmission and the control information is transmitted on a plurality of OFDMA symbols associated with that resource unit.

FIG. 4B illustrates scenarios in which uplink control information is multiplexed with uplink data on the physical uplink shared channel. Multiplexing between the uplink control channel and the uplink data may be based on time division duplex and/or frequency division duplex. In this scenario, physical uplink control channel resources are left unused.

Assuming that the new radio air interface will be based on cyclic prefix-OFDMA, the Cubic metric (actual reduction in power capability, or power de-rating, of a typical power amplifier in a mobile handset) and/or the Peak-to-average power ratio may not be important. As a result of this, always transmitting uplink control information on the physical control channel separately from the uplink data transmission is a useful default mechanism. Such a system (i.e. keeping the data and control information transmissions separate from each other) is also useful for maintaining a simpler system (as the uplink control information structure does not vary in the presence of uplink data). However, there are problems associated with keeping these channels separate.

For example, the link performance of the uplink may not be optimized, due to a large reference signal overhead, limitations on the frequency diversity for transmitting the uplink control information, and as the uplink control information does not benefit from any additional scheduling gain. As another example, there is typically limited support for having a large uplink control information payload on physical uplink control channel, and there can be an increased downlink control information overhead (for multiple uplink grants) in the case of aperiodic channel state information and physical uplink shared channel options (provided that uplink control information cannot be otherwise mapped to the physical uplink control channel).

The inventors have thus realized that it would be useful to also provide support for transmitting uplink control information multiplexed with the uplink data transmission in the new radio system.

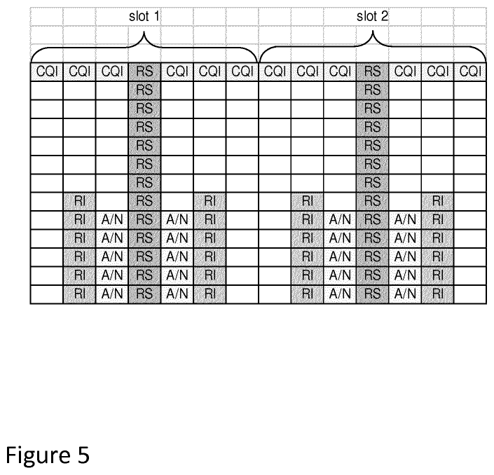

Multiplexing the uplink control information onto the uplink data channel transmissions is currently used in LTE. An example of this is shown in FIG. 5.

FIG. 5 depicts two slots for the uplink. In the fourth discrete Fourier transform-spread-OFDMA symbol of each slot, there is provided a reference signal transmission (RS) across the entire frequency spectrum. Further, in the first resource element of each discrete Fourier transform-spread-OFDMA symbol bar the fourth discrete Fourier transform-spread-OFDMA symbol, there is provided a channel state information (which may comprise information such as the channel quality indicator and the precoding matrix indicator. These entities are feedback values indicative of the state of a link between an apparatus receiving transmissions and the apparatus making transmissions). Rank Indicators are provided in the last six resource elements of the second and sixth discrete Fourier transform-spread-OFDMA symbols of each slot (a rank indicator is also sometimes considered to form part of the channel state information feedback provided by an apparatus to a network apparatus for evaluating the state of a link). Acknowledgements and/or Negative acknowledgments (A/N) are shown in the bottom five resource elements of the third and fifth discrete Fourier transform-spread-OFDMA symbols of each slot. The remaining discrete Fourier transform-spread-OFDMA symbols are used to transmit regular uplink data.

This multiplexing solution defined in LTE is not feasible for new radio due to a plurality of reasons. These reasons include at least the following. The time division multiplexing mechanism used in LTE does not provide frequency diversity in the case when OFDMA is applied. There is therefore a need to provide a simpler mechanism to that of LTE operation. For example, in the case of hybrid automatic repeat request acknowledgements on the physical uplink shared channel, the LTE system applies data puncturing which results in multiple hypothesis testing at the base station side. LTE does not capitalize the power domain as an option to adjust link quality between uplink control information and uplink data. Further, the uplink control information coding arrangement in LTE is not optimal from performance and latency points of view in new radio systems.

Furthermore, the system of FIG. 5 is also not applicable to LTE operation when a short 2-symbol time transmission interval operation is used, as there is simply no room to map the uplink control information in the same way as the legacy case.

In light of this, the inventors have realized that a new mapping operation needs to be developed that addresses at least one of the above-mentioned issues.

In general, the following relates to providing a mapping operation that enables frequency diversity for transmitting uplink control information. The uplink control information may be multiplexed on the same channel as uplink data, such as when it is transmitted on an uplink shared channel. In general, the control information is indicative of a quality of a link between a transmitter and a receiver (e.g. between a user apparatus and a base station). The control information may comprise at least one of channel state information (which comprises a precoding matrix indicator and channel quality indication), rank indicator and ack/nack for hybrid automatic repeat request feedback (or the like).

To provide the above-mentioned frequency diversity, the available frequency resources are partitioned into a plurality of frequency groups, such that there are at least two distinct (non-overlapping) sets of frequencies that may be allocated for transmission of the control information in a plurality of ways. Some of these ways are detailed below in the more specific examples. Frequency resources within the partitioned groups that are not assigned for transmitting uplink control information may be used to transmit regular uplink data. In other words, the available frequency resources may correspond to frequency resources on an uplink shared channel. Within each frequency group, the uplink control information being mapped to a resource element within that group may be mapped independently of uplink control information being mapped to a resource element of another frequency group.

As mentioned above, the same mapping operation may be applied independently in each of a user apparatus and a network apparatus communicating with the user apparatus. This may be performed in several ways.

For example, the network apparatus may determine that uplink control information should be transmitted on the uplink shared channel and transmit a trigger message to the user apparatus indicating this. On receipt of the trigger message, the user apparatus may identify which resource elements of the shared channel the uplink control information should be transmitted on, using the mapping operation, before transmitting on those identified resource elements. The network apparatus may separately apply the mapping operation to determine on which shared channel resource elements the control information will be transmitted.

In an alternative example, on receipt of the trigger message, the user apparatus may not perform such a mapping operation if the trigger message comprises an indication of which resources should be used for such uplink control information transmissions on the uplink shared channel.

In some examples, no trigger message is transmitted from the network apparatus and the user apparatus. Instead, each device is programmed with a set of rules for determining when the uplink control information should be transmitted on the uplink shared channel. These rules are the same (and may be applied independently) in each of the user apparatus and the network apparatus. The rules may relate to current link conditions and/or to a service being provided through the link.

It is thus understood in the below that where references are made to the network apparatus performing a mapping operation, this also encompasses those described actions being performed by the user apparatus.

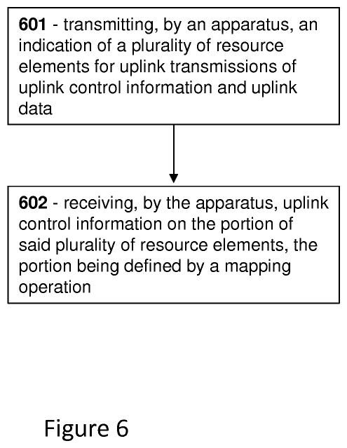

An example method that may be applied by a network apparatus or the like is described by reference to the flowchart of FIG. 6. Although the following refers to a network apparatus (such as an access point/base station/eNB), it is understood that any apparatus may perform the following. The described actions may be executed in a variety of ways using hardware, software or a combination thereof. In one use case, the described actions may be executed when computer code stored in at least memory of the network apparatus executes on at least one processor of the network apparatus.

At 601, the network apparatus is configured to transmit an indication of a plurality of resource elements for uplink transmissions of uplink control information and uplink data. The indication may be transmitted to a user apparatus. The indication may indicate that the plurality of resources are to be used for both uplink control information and uplink data. An identification of the plurality of resources may be provided separately via a separate communication to the indication. An identification of the plurality of resources may be provided in the same communication as the indication. As mentioned above, at least some of the plurality of resource elements may correspond to resource elements of an uplink shared channel (e.g. a physical uplink control channel). A resource element is the smallest unit of frequency and time in a particular transmission system. In LTE systems, this is an OFDMA symbol located on a single subcarrier. If discrete Fourier transform-spread-OFDMA is applied, the resource element is a single carrier-FDMA symbol located on a single (virtual) subcarrier. This determination may relate to a general number of resources to be assigned to all uplink transmissions, only control channel resources, or only shared channel resources, depending on how the network apparatus is configured.

At 602, the network apparatus is configured to receive uplink control information on a portion of said plurality of resource elements, said portion being defined by a mapping operation. The portion is a subset of the plurality of resource elements (i.e. not all of the plurality of resource elements). The portion comprises more than one resource element.

The mapping operation may comprise a plurality of rules for executing said mapping. These rules may be selected in dependence on the specifics of each system and the particular communication protocol being used. Some example rules are provided below. However, in general, the mapping operation comprises at least the steps partitioning the plurality of resource elements to define a predetermined number of frequency domain resource element sets and mapping the uplink control information to the plurality of resource elements in the predetermined number of frequency domain resource element sets to identify the portion of the plurality of resource elements. The term “frequency domain resource element set” is used in this context to denote a set (or group) of resource elements that is defined with respect to the frequency domain. Prior to mapping the uplink control information to the plurality of resource elements, the mapping operation may further comprise partitioning the control information into the same number of sets as the predetermined number of frequency domains. The mapping may then be performed such that each control information set is mapped within a single predetermined frequency domain. Examples of the different ways of partitioning the control information and mapping within respective sets is detailed below.

The network apparatus may be configured to use the mapping operation to determine, or otherwise identify, a location of those received resource elements that correspond to the uplink control information. The mapping operation performed by the network apparatus may correspond to the inverse of the mapping operation performed by the transmitting user apparatus (i.e. it may be a demapping operation). The locations may be set by prior programming, or may be determined whilst in use i.e. on the fly/dynamically.

The step of partitioning the plurality of resource elements into time or frequency domains may be performed in a number of ways. In one example, the partitioning is performed such that each group/set of resource elements in each time instance is contiguous in frequency. By this, it is meant that the resource elements are split into groups forming a continuous bandwidth in the frequency spectrum. However, it is understood that the resource elements may be partitioned such that at least one group/set of resource elements is not contiguous in frequency. In general, at least two groups are formed when the non-contiguous option is employed.

The step of partitioning may comprise partitioning all of the available frequency spectrum for uplink transmissions of uplink control information and uplink data. The step of partitioning may comprise partitioning only part of the available frequency spectrum (for example, only that part relating to uplink shared channel resources).

The network apparatus may be configured to provide an indication of the portion of said plurality of resource elements to another apparatus, such as to a user apparatus. The user apparatus may use this indication (as detailed below) for determining when to transmit control information. The indication can be conveyed in the form of uplink scheduling grant. In LTE, there is no indication to include HARQ-ACK on a frequency division duplex uplink grant (i.e. in LTE, a grant for signalling this type of uplink control information is not separately made). Therefore, if the presently described system is to be employed in such a system, the user apparatus may receive the downlink assignment and consequently transmit HARQ-ACK bits on the uplink shared channel. If the user apparatus has not received the downlink assignment, the HARQ-bits will be absent from the uplink shared channel. Consequently, the network apparatus may be configured to test both hypothesis (i.e. to assume both of the case where the user apparatus has received a downlink assignment and includes the HARQ-ACK bits, and the case where the user apparatus has not received a downlink assignment and HARQ-ACK bits are absent from the uplink shared channel).

The indication may take the form of a trigger message. In other words, the indication may trigger the user apparatus to perform the actual mapping operation to determine which resource elements are to be used for an uplink control information transmission. The allocation of resources for transmitting uplink control information via a physical uplink shared channel can be triggered with an uplink grant. In other words, the trigger message may be a grant for uplink shared channel resources. The trigger message may be a downlink transmission for which HARQ feedback (or other control information) is requested. As a specific example (utilizing proposed forms of the new radio system), such an uplink grant may be transmitting by including L1 control information in a regular uplink grant message. The trigger may indicate that the UE should transmit a particular type of control information on the uplink shared channel (e.g. HARQ-ACK feedback for all hybrid automatic repeat request processes). The trigger message may also indicate particular downlink resources to which the uplink control information should relate. For example, the trigger message may indicate one or more downlink transport blocks that have been scheduled, and the corresponding HARQ-ACK feedback should be provided using the physical uplink shared channel.

The indication may identify the actual mapping operation to be applied by the user apparatus for the user apparatus to determine itself which resource elements are to be used for an uplink control information transmission. The indication may be in the form of an explicit/direct identification of which resources may be used for transmitting the uplink control information. For example, the indication may comprise a bitmap that indicates which resources have been assigned for which types of information (e.g. data transmission and/or uplink control information). The indication may be indirect. For example, the indication may configure a plurality of parameters for uplink transmission (such as which lower layer protocols are to be used for transmission). The user apparatus may be configured to access a database that correlates particular configurations of the plurality of parameters with specific mapping operations to be applied, and be further configured to utilise this database to determine which mapping operation to be applied.

Prior to performing step 602, the network apparatus may be configured to determine whether or not the identifying/mapping operation needs to take place at all. For example, if there are enough resource elements available on an uplink control channel for transmitting the uplink control information, it is not necessary to further allocate resource elements on the shared channel for transmitting the uplink control information (or a portion thereof).

To this effect, the network apparatus may be configured to determine a number of resource elements required for transmitting the uplink control information; and perform said identifying only if the number of resource elements is larger than a threshold value. The threshold value may correspond to a number of resource elements available on an uplink control channel. The determination and threshold may relate to the entire number of bits needed for the uplink control information. The determination and threshold may relate to only those bits needed for transmitting a particular type (or types) of uplink control information. As an example of this, if the number of HARQ-ACK bits is below a certain threshold (e.g. 3 bits), the uplink control information may be conveyed via the physical uplink control channel alone. It the number of HARQ-ACK bits is at or above said threshold, the uplink control information may also be multiplexed onto the uplink shared channel.

The portion of said plurality of resource elements are all located on an uplink shared channel.

The network apparatus may be configured to determine the predetermined number of frequency domain resource element sets. This determining may be performed in dependence on current uplink transmission conditions. For example, there may be a greater number of frequency domain resource element sets used when the interference conditions get worse. In other words, when the network apparatus determines that a link condition has worsened since the last time the predetermined number was determined, then the predetermined number may increase. The predetermined number of frequency domain resource element sets may also or instead depend on the service type. For example, URLLC (Ultra Reliable Low Latency Communications) service may require a higher number of frequency domain resource element sets to maximize the reliability. The predetermined number of frequency domain resource element sets may also or instead depend on the radio channel characteristics.

As mentioned above, there are a number of ways in which the mapping operation may be performed.

In these examples, the said uplink control information comprises first and second types of uplink control information. The first type may be the rank indicator and/or the HARQ-ACK information. The second type may be other types of channel state information, such as a precoding indicator and/or channel quality indicator.

Further, for each of the first and second types of uplink control information, a number of resource elements required for transmitting the first and second types of uplink control information may be determined.

In one example, the mapping operation may comprise: mapping all of the first type of uplink control information to a first frequency domain resource element set of the predetermined number of frequency domain resource element sets; and mapping all of the second type of uplink control information to a second frequency domain resource element set of the predetermined number of frequency domain resource element sets. In other words, different types of uplink control information are mapped to resource elements in respective frequency domain resource element sets of the predetermined number of frequency domain resource element sets.

In another example, the mapping operation may comprise: mapping all of the first type of uplink control information to a first frequency domain resource element set of the predetermined number of frequency domain resource element sets; and mapping some of the second type of uplink control information to the first frequency domain resource element set and some of the second type of uplink control information to a second frequency domain resource element set of the predetermined number of frequency domain resource element sets.

In another example, the mapping operation may comprise: mapping some of the first type of uplink control information to a first frequency domain resource element set of the predetermined number of frequency domain resource element sets and some of the first type of uplink control information to a second frequency domain resource element set of the predetermined number of frequency domain resource element sets; and mapping some of the second type of uplink control information to the first frequency domain resource element set and some of the second type of uplink control information to the second frequency domain resource element set. In other words, in this example different types of uplink control information are mapped to resource elements in the same frequency domain resource element sets as other types of uplink control information.

In one mapping example for the cyclic prefix-OFDM, the frequency domain resource element set mapping of uplink control information onto the physical uplink shared channel resources may use the following mechanism. Firstly, the uplink control information is mapped to the resource elements immediately adjacent to a demodulation reference signal (i.e. a reference signal used for enabling data reception). In this case UCI mapping starts from a resource element adjacent to a resource element used for transmitted the demodulation reference signal, and every other uplink control information symbol is mapped on an opposite side of the allocated subcarriers/bandwidth than the uplink control information symbol.

As described in some of the following examples, the mapping order of different uplink control information types may vary in dependence on the type of uplink control information. In one example, HARQ-ACK and first part of the channel state information (e.g. the rank indicator) are mapped onto the physical uplink shared channel resources first (starting from the 1^{st} OFDMA symbol), followed by the second part of the channel state information (e.g. the precoding matrix indicator and/or the channel quality indicator). This example may be used to minimize the latency for all uplink control information feedback, as it is all provided within a single transmission period rather than over one transmission period.

In another example, the HARQ-ACK and first part of the channel state information are mapped onto the physical uplink shared channel resources first (starting from the 1^{st} OFDMA symbol), whilst the second part of the channel state information is mapped onto the physical uplink shared channel starting from the last OFDMA symbol of the slot (or subframe, or mini-slot) or from another predefined OFDMA symbol of the slot. This example may minimize the latency for acknowledge/negative acknowledgements and physical uplink shared channel data reception, while less time-critical and computation intensive CSI feedback is delayed.

In one example, the uplink control information resource elements convey not only uplink control information, but also additional reference signals for improving the uplink control information reception performance. For example, the reference signal may correspond to the demodulation reference signal currently used in LTE. In other words, the sequence of such an additional reference signal may be a constant amplitude zero autocorrelation (CAZAC) sequence.

In a mapping example that is relevant to both new radio and LTE operation, discrete Fourier transform-spreading-OFDMA is applied (instead of cyclic prefix-OFDMA) when transmitting on the physical uplink shared channel. In this example, there are separate (DFT-S-OFDMA) symbol(s) for the demodulation reference signal symbol (without any data) and the uplink control information is mapped to data symbols only. Similar resource element mapping as outlined above is applied for both discrete Fourier transform-spreading-OFDMA and cyclic prefix-OFDMA. This arrangement ensures that single carrier properties of the transmitted signal can be maintained also with the proposed resource element mapping.

Some specific examples of mapping procedures/mechanisms are now described with reference to the Figures. Various of these described mapping procedures have a plurality of aims. These aims include providing a sufficient amount of frequency diversity for improving the transmission on uplink control data (through the partitioning of the available frequencies into a plurality of frequency clusters (two and four frequency clusters are illustrated in the following)). The following also aims to multiplex between uplink data and uplink control information onto the same channel (e.g. the uplink shared channel). The multiplexing may be provided for different types of uplink control information (in a way that provides sufficient frequency diversity for each uplink control information type). It is also an aim to provide a multiplexing mechanism in the case that either of cyclic prefix-orthogonal frequency division multiple access and discrete Fourier transform-spread-orthogonal frequency division multiple access may be used in the same system.

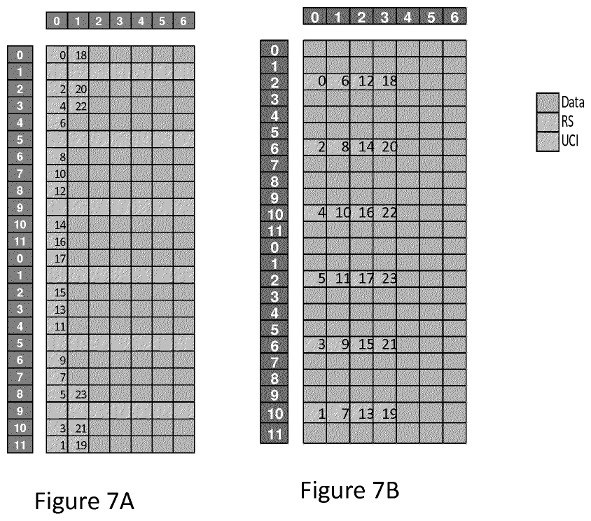

FIGS. 7A and 7B illustrate two possible uplink control information mapping operations. In both of these Figures, time runs along the x-axis in OFDMA symbols. There are seven OFDMA symbols. Frequency runs along the y axis in subcarriers. There are 24 subcarriers depicted (as two sets of 12, as the frequencies have been partitioned into two groups). Aside from the labelling at the extreme top and left hand sides of these Figures, each small box within the Figures represents a resource element. In both Figures, all of the resource elements located in the first, fifth and ninth subcarriers of each set of 12 subcarriers are utilized for reference signal transmissions. Resource elements used for uplink control information are labelled with numbers indicative of their order. It should be noted that reference signal allocation is just an example. The principle is applicable to any reference signal allocation scheme.

In FIG. 7A, even numbered uplink control information is located in the top set of 12 subcarriers, such that when the first OFDMA symbol is completely filled with uplink control information (from the highest frequency in the top set to the lowest frequency in the top set), the mapping continues filling up the second OFDMA symbol. The odd numbered uplink control information is located in the bottom set of 12 subcarriers, such that when the first OFDMA symbol is completely filled with channel state information (from the lowest frequency in the bottom set to the highest frequency in the bottom set), the mapping continues filling up the second OFDMA symbol from the lowest frequency. The uplink control information is mapped to avoid mapping into resource elements comprising the reference signal.

In FIG. 7B, the even numbered uplink control information is located in the top set of 12 subcarriers, such that only selected subcarriers are filled with uplink control information (e.g. the second, sixth and tenth subcarriers in the depicted example). When the lowest of these three frequencies in filled in a particular OFDMA symbol (from the highest frequency in the top set to the lowest frequency in the top set), the next channel state information symbol is instead mapped to the highest frequency of the immediately adjacent OFDMA symbol. Similarly, the odd numbered channel state information is located in the bottom set of 12 subcarriers, such that only selected subcarriers are filled with uplink control information (e.g. the second, sixth and tenth subcarriers in the depicted example). When the highest of these three frequencies in filled in a particular OFDMA symbol (from the lowest frequency in the bottom set to the highest frequency in the bottom set), the next uplink control information symbol is instead mapped to the lowest frequency of the immediately adjacent OFDMA symbol.

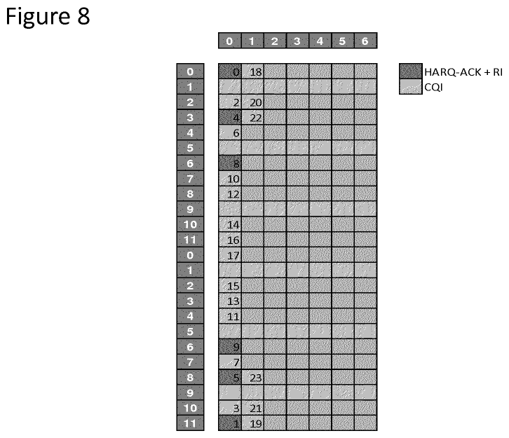

Another mapping operation is described in relation to FIG. 8. Like the example of FIGS. 7A and 7B, time runs along the x-axis in OFDMA symbols. There are seven OFDMA symbols. Frequency runs along the y axis in subcarriers. There are 24 subcarriers depicted (as two sets of 12, as the frequencies have been partitioned into two groups). Aside from the labelling at the extreme top and left hand sides of these Figures, each small box within the Figures represents a resource element. In both Figures, all of the resource elements located in the first, fifth and ninth subcarriers of each set of 12 subcarriers are utilized for reference signal transmitting. Resource elements used for uplink control information are labelled with numbers indicative of their order.

FIG. 8 illustrates a similar mapping mechanism to the mechanism of FIG. 7A. However, FIG. 8 differs from the example of FIG. 7A in that the different types of uplink control information is displayed. As depicted therein, the 0^{th}, 1^{st}, 4^{th}, 5^{th}, 8^{th} and 9^{th} control information resource elements are designated as being used for HARQ-ACK information and/or rank indicator information whilst the other control information resource elements are used for other channel state information, such as channel quality indicator.

In one example implementation, joint coding is applied between HARQ-ACK and the rank indicator. Where beamforming is used, joint coding may also be applied between HARQ-ACK and/or the rank indicator and/or the beam index (a beam index identifies a transmit antenna and is commonly used to identify a transmit antenna providing a best link quality relative to the other transmit antennas). As previously mentioned, the rank indicator may be viewed as channel state information. However, other channel state information (such as the channel quality indicator and the precoding matrix indicator) and the payload may depend on the value of the rank indicator. Because of this, it is preferred that separate coding be applied between the other channel state information and the rank indicator. If the HARQ-ACK is jointly coded with the rank indicator, as per the example above, this would then result in separate coding between the other channel state information and the combination of ACK-NACK and rank indicator. Therefore, FIG. 8 may be seen as an example of a mapping operation that may be used when such a division between uplink control information is made.

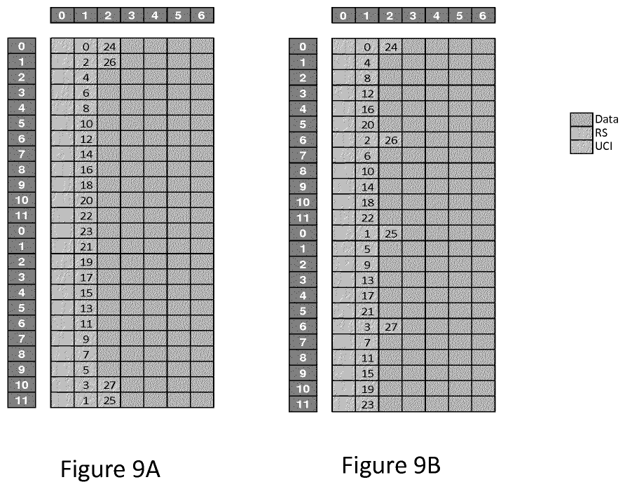

Another mapping operation is described in relation to FIGS. 9A and 9B. Like the example of FIGS. 7A and 7B, time runs along the x-axis in OFDMA symbols. There are seven OFDMA symbols. Frequency runs along the y axis in subcarriers. There are 24 subcarriers depicted (as two sets of 12, as the frequencies have been partitioned into two groups). Aside from the labelling at the extreme top and left hand sides of these Figures, each small box within the Figures represents a resource element. Resource elements used for uplink control information are labelled with numbers indicative of their order.

Both of FIGS. 9A and 9B illustrate mapping operations that may be applied for both cyclic prefix-OFDMA and discrete Fourier transform-spread-OFDMA. In each example, every carrier in the 0^{th} symbol is used for transmission of a reference signal.

In FIG. 9A, the frequencies are again split up into two groups, and the control information is mapped onto the resource elements such that even-numbered uplink control information is mapped onto the first frequency group whilst odd-numbered uplink control information is mapped onto the frequency group. Each group of uplink control information is mapped to completely fill the subcarriers of a first subcarrier before wrapping around to the initial subcarrier on an immediately adjacent symbol. The remaining resource elements are used for uplink data transmission.

FIG. 9B differs from FIG. 9B in that there are four frequency domain resource element clusters/sets, with six subcarriers in each cluster. The goal of this arrangement is to maximize the degree for frequency diversity in the case with small number of uplink control information resource elements. All of the even-numbered control information still maps to the upper 12 subcarriers, with every other even-numbered control information being located in the top half of the upper 12 subcarriers and the remaining even-numbered control information being located in the bottom half of the upper 12 subcarriers. All of the odd-numbered control information still maps to the lower 12 subcarriers, with every other odd-numbered control information being located in the top half of the lower 12 subcarriers and the remaining odd-numbered control information being located in the bottom half of the lower 12 subcarriers.

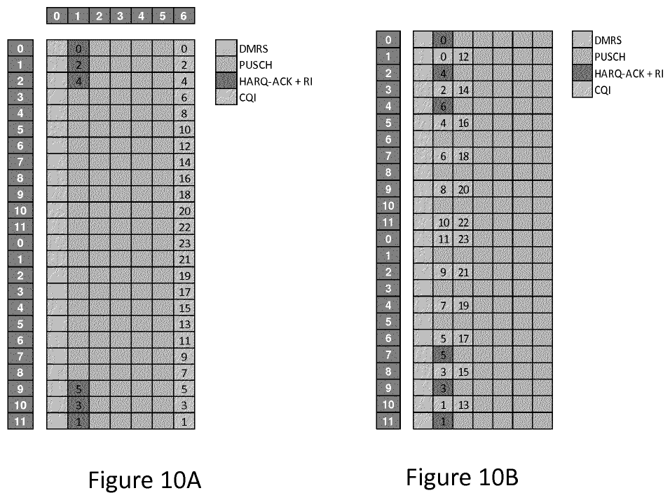

Another mapping operation is described in relation to FIGS. 10A and 10B. Like the example of FIGS. 7A and 7B, time runs along the x-axis in OFDMA symbols. There are seven OFDMA symbols. Frequency runs along the y axis in subcarriers. There are 24 subcarriers depicted (as two sets of 12, as the frequencies have been partitioned into two groups). Aside from the labelling at the extreme top and left hand sides of these Figures, each small box within the Figures represents a resource element. Resource elements used for uplink control information are labelled with numbers indicative of their order. Like FIGS. 9A and 9B, in each example, every carrier in the 0^{th} OFDMA symbol is used for transmission of a reference signal.

Like FIG. 8, FIGS. 10A and 10B distinguish between the different types of uplink control information. Both of the examples of FIGS. 10A and 10B may be used for discrete Fourier transform-spread-OFDMA operations, and/or cyclic prefix-OFDMA operations.

FIG. 10A indicates a first possible mapping operation for HARQ-ACK and/or RI information (first uplink control information) and the other channel state information (second uplink control information).

As depicted in FIG. 10A, the 1^{st} OFDM symbol is used for mapping the first control information (such that even-number first control information is mapped onto multiple subcarriers of the upper frequency set/partition of the 1 st OFDMA symbol whilst odd-number second control information is mapped onto multiple subcarriers of the lower frequency set/partition of the first OFDMA). Further, the 6^{th} OFDMA symbol is used for mapping the second control information (such that even-number second control information is mapped onto multiple subcarriers of the lower frequency set/partition of the last OFDMA symbol whilst odd-number second control information is mapped onto multiple subcarriers of the lower frequency set/partition of the last OFDMA). It is understood that references herein to a last OFDMA symbol (and/or to a last unit time of a scheduling unit) refer to a last available OFDMA symbol/unit time within that scheduling unit. A scheduling unit refers to a unit of time over which a transmission is to be made. The scheduling unit is a unit of time granted to a user apparatus for uplink transmissions within a scheduling grant transmitted by a network apparatus. For example, a scheduling unit may be a slot, a resource block, a mini-slot, a subframe, etc. This type of mapping (where a first type (or types) of control information is mapped to an earlier (in time) part of the scheduling unit to a second type (or types) of control information) is usefully applied when the first type (or types) or information is considered to be more time critical than the second type (or types) of control information. By this, it is meant that the latency of the network may be reduced by a larger amount by receiving the first type(s) of control information than it can by receiving the second type(s) of control information. The first type(s) of information may be a rank indicator and/or a HARQ-ACK and/or a beam index (for indicating a transmitting antenna providing the best communication quality). The second type(s) of information may be a channel quality indicator and/or a precoding matrix indicator.

In contrast to the example of FIG. 10A, in FIG. 10B the first and second types of control information are transmitted on the same OFDMA symbols, but are allocated alternate subcarriers. Thus, for example, the 0^{th}, 2^{nd}, 4^{th}, 6^{th}, 8^{th} and 10^{th} subcarriers of the upper frequency group and the 1^{st}, 3^{rd}, 5^{th}, 7^{th} 9^{th} and 11^{th} subcarriers of the lower frequency group may be assigned to the first control information whilst the remaining subcarriers are assigned to the second control information. When there stops being control information to map, that subcarrier/resource element may be used for uplink data transmissions. When the assigned subcarriers on a first OFDMA symbol are filled, the assigned subcarriers on an immediately adjacent OFDMA symbol may be used.

These approaches of FIGS. 10A and 10B may be preferable to the example of FIG. 8 when the mapping is effected by a network apparatus, as in these examples each type of uplink control information is always in a fixed location within a particular physical resource block (set of 12 subcarriers). In other words, the channel state information location does not vary according to presence of HARQ-ACK+RI.

When transmitting regular data on the uplink shared channel multiplexed with the uplink control information, the regular data may be rate matched (i.e. mapped) around the uplink control information such that it is not mapped onto any resource elements identified as being used for transmitting the uplink control information. In other words, the regular data may be mapped onto the resource elements of the uplink shared channel so as to exclude those resource elements onto which the control information is mapped. This mapping around/rate matching may be performed as part of the same mapping operation as the mapping of uplink control information to resource elements on the uplink shared channel. This mapping around/rate matching may be performed as part of a different mapping operation as the mapping of the uplink control information to resource elements on the uplink shared channel. This results in a system in which there is no physical uplink shared channel variation in quality resulting from the presence of uplink control information in the shared channel. This is different to the current LTE system, which punctures data symbols for HARQ-ACK transmission purposes. Further, there is less room for apparatuses to incorrectly designate the resource elements as being used for other purposes, given the explicit trigger message described above. Further, the data format does not vary according to potential downlink/uplink grant failure.

When it is determined to transmit uplink control information of a particular type on the uplink shared channel, this process may result in at least one resource elements remaining on the uplink control channel being unused. To address this, the network apparatus may allocate any unused uplink control channel resource element to another user apparatus in a dynamic (i.e. on the fly/whilst in use) manner. This utilizes the available resources efficiently and reduces resource wastage.

When determining whether or not a shared channel needs to be used to transmit the uplink control information, the network apparatus and/or the user apparatus may be configured to use a dimensioning process, such as is currently used in LTE. Although the following is described in terms of the user apparatus, it is understood that the same process may be performed by the network apparatus.

A modified form of the equation used for uplink control information when dimensioning in LTE is indicated below. This equation shows the current uplink control information dimensioning formula used for HARQ-ACK and rank indicator when multiplexed with uplink data on the physical uplink shared channel, and comprises an addition input parameter, P_{O}^{UCI}, which corresponds to (average) power difference (in linear scale) between resource element allocated to UL data and resource element allocated to UL control symbol(s), respectively.

P_{O}^{UCI} may be a parameter configured by higher layer signalling. It may be defined separately for different uplink control information types such as HARQ-ACK, the rank indicator and other types of channel state information. β_{offset}^{PUSCH} is a parameter used to adjust the uplink control information quality with respect to the regular uplink shared channel data and it is configured via higher layer signalling for each UCI type (i.e. according to the present example, separately for HARQ-ACK/rank indicator and channel quality indicator). Cyclic prefix-OFDMA-specific values for β_{offset}^{PUSCH} may be defined.

When the user apparatus transmits HARQ-ACK bits or rank indicator bits on the uplink, the user apparatus may be configured to determine the number of coded symbols Q′ for HARQ-ACK or rank indicator as

$${Q}^{′} = min ( ⌈ \frac{O \cdot {M}_{sc}^{PUSCH - initial} \cdot {N}_{symb}^{PUSCH - initial} \cdot {P}_{O}^{UCI} \cdot {β}_{offset}^{PUSCH}}{{\sum }_{r = 0}^{C - 1} {K}_{r}} ⌉ , 4 \cdot {M}_{sc}^{PUSCH} )$$

where O is the number of ACK/NACK bits or rank indicator bits, M_{sc}^{PUSCH} is the scheduled bandwidth for physical uplink shared channel transmission in the current sub-frame for the transport block, expressed as a number of subcarriers, and N_{symb}^{PUSCH-initial} is the number of single carrier-frequency division multiple access symbols per subframe for initial physical uplink shared channel transmission for the same transport block given by N_{symb}^{PUSCH-initial}=(2·(N_{symb}^{UL}−1)−N_{SRS}), where N_{SRS} is equal to 1 if UE is configured to send physical uplink shared channel and the sounding reference signal in the same subframe for initial transmission or if the physical uplink shared channel resource allocation for initial transmission even partially overlaps with the cell specific sounding reference signal subframe. Otherwise N_{SRS} is equal to 0. M_{sc}^{PUSCH-initial}, C, and Kᵣ are obtained from the initial physical downlink control channel for the same transport block. The term (4·M_{sc}^{PUSCH}) corresponds to the maximum size of the HARQ-ACK or rank indicator field. Due to different approach used in the proposed solution relative to LTE (i.e. rate matching/mapping around channel state information instead of puncturing, which is used in LTE), such term may not be needed, depending on the particular form of the implemented network. N_{symb}^{PUSCH-initial} may be seen as the number of data symbols available for PUSCH in the current slot (or mini-slot).

Thus, in light of the above, it may be said that the network apparatus may be further configured to determine a number of resource elements required for transmitting the uplink control information in dependence on a power difference between a power assigned to a resource element for uplink data transmission and a power assigned to a resource element for uplink control information transmission. Said determining may comprise receiving, by a user apparatus, said power difference from another apparatus, such as a network apparatus like a base station. This power difference may be signalled used higher layer signalling, such as radio resource control-level signalling. The power difference may be indicated in the same message from the network apparatus to the user apparatus as the above-mentioned trigger message/scheduling grant message. The power message may be indicated in a different message from the network apparatus to the user apparatus as the above-mentioned trigger message/scheduling grant message.

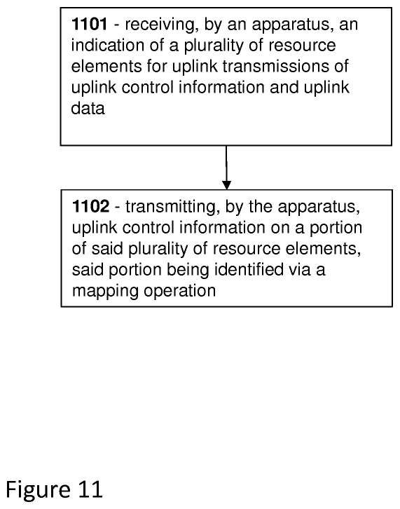

There is further described operations associated with an entity configured to transmit on the uplink channels (such as a user apparatus, although it is understood that this uplink transmitting apparatus is not necessarily a user apparatus). This entity is described with reference to the flowchart of FIG. 11. The described actions may be executed in a variety of ways using hardware, software or a combination thereof. In one use case, the described actions may be executed when computer code stored in at least memory of the user apparatus executes on at least one processor of the user apparatus. It is understood, as mentioned above, that the user apparatus and the network apparatus may be configured to separately (or otherwise independently) apply the mapping operation. Therefore, details mentioned above in relation to the identifying these resources also apply when the user apparatus identifies those resources to be used for transmitting uplink control information.

At 1101, the user apparatus is configure to receive an indication of a plurality of resource elements for uplink transmissions of uplink control information and uplink data. This indication may take the form of a scheduling grant for resources on an uplink shared channel.

At 1102, the user apparatus may be configured to transmit uplink control information on a portion of said plurality of resource elements, said portion being identified via a mapping operation. Said mapping operation may comprise: partitioning the plurality of resource elements to define a predetermined number of frequency domain resource element sets; and mapping the uplink control information to the plurality of resource elements in the predetermined number of frequency domain resource element sets to identify the portion of the plurality of resource elements. The indication may be in form of an actual mapping operation to be applied by the user apparatus for the user apparatus to determine itself which resource elements are to be used for an uplink control information transmission. The indication may be in the form of an explicit/direct identification of which resources may be used for transmitting the uplink control information. For example, the indication may comprise a bitmap that indicates which resources have been assigned for which types of information (e.g. data transmission and/or uplink control information). The indication may be indirect. For example, the indication may configure a plurality of parameters for uplink transmission (such as which lower layer protocols are to be used for transmission). The user apparatus may be configured to access a database that correlates particular configurations of the plurality of parameters with specific mapping operations to be applied, and be further configured to utilise this database to determine which mapping operation to be applied.

The user apparatus may be configured to receive an indication of a portion of said plurality of resource elements for transmission of uplink control information. The indication may correspond to the indication transmitted in step 603, mentioned above. To this effect, said indication may indicate the mapping operation.

In the above, is assumed that, uplink control information is conveyed primarily via the physical uplink control channel (either a short physical uplink control channel time division duplexed with uplink data, or a long physical uplink control channel frequency division multiplexed with uplink data). However, when desirable, uplink control information may be moved to the physical uplink shared channel. It may be considered desirable to move the uplink control information in this way following a determination that a larger number of resource elements are required to transmit the uplink control information than the resource elements available in the uplink control channel. This determination may be based on the signalling received from a network apparatus, such as a base station, eNB, and/or access point to a network.

There are multiple advantages to the above-described mapping mechanisms. For example, there is a reduced mapping complexity relative to the LTE mapping operation. Further, the uplink control information multiplexing operation may be fully under the control of the network apparatus. Large amounts of uplink control information may be transmitted in a single transmission interval with relatively small overhead. Further, the above-described mechanisms may be applied to both discrete Fourier transform-spread-OFDMA and cyclic prefix-OFDMA, which means that it may be applied to both legacy (LTE) systems in addition to new radio systems. Such flexibility in the mapping is also advantageous as new radio is being further defined and developed. In certain more specific aspects, mapping the uplink control information so that it is mapped to resource elements close to the reference signal transmission allows for good demodulation. Further, mapping any time-critical parts of the uplink control information towards the beginning (in time) of the transmission may minimize the latency of the system. Finally, the above-described mapping mechanism may extend the coverage of the system when the modified dimensioning formula described above is used.

As discussed above, it is noted that the above discussed issues are not limited to any particular communication environment, but may occur in any appropriate communication system. Some embodiments may for example be used in 4G and/or 5G, for example new radio/5G technologies or similar technologies.

Also, the mapping operation described with respect to the above is especially beneficial with OFDMA schemes which do not comprise a discrete Fourier transform operation for spreading over the whole band. An example of such an OFDMA scheme is cyclic prefix-OFDMA. For legacy reasons, it may also be useful to apply the above mentioned mapping operation to discrete Fourier transform-spread-OFDMA. However, this extension is not necessary and may be omitted.

In the above references to a trigger message, it is understood that the trigger message may cause the user apparatus to transmit uplink control information on the uplink control channel in addition to on the shared channel. In other words, on receipt of the trigger message, the user apparatus may select between uplink control channel resources and uplink shared channel resources for at least one type of uplink control information.

The required data processing apparatus and functions may be provided by means of one or more data processors. The described functions may be provided by separate processors or by an integrated processor. The data processors may be of any type suitable to the local technical environment, and may include one or more of general purpose computers, special purpose computers, microprocessors, digital signal processors (DSPs), application specific integrated circuits (ASIC), gate level circuits and processors based on multi core processor architecture, as non-limiting examples. The data processing may be distributed across several data processing modules. A data processor may be provided by means of, for example, at least one chip. Appropriate memory capacity can be provided in the relevant devices. The memory or memories may be of any type suitable to the local technical environment and may be implemented using any suitable data storage technology, such as semiconductor based memory devices, magnetic memory devices and systems, optical memory devices and systems, fixed memory and removable memory. One or more of the steps discussed in relation to FIGS. 6 and/or 11 may be performed by one or more processors in conjunction with one or more memories.

An appropriately adapted computer program code product or products may be used for implementing the embodiments, when loaded or otherwise provided on an appropriate data processing apparatus. The program code product for providing the operation may be stored on, provided and embodied by means of an appropriate carrier medium. An appropriate computer program can be embodied on a computer readable record medium. A possibility is to download the program code product via a data network. In general, the various embodiments may be implemented in hardware or special purpose circuits, software, logic or any combination thereof. Embodiments of the inventions may thus be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

It is noted that whilst embodiments have been described in relation to certain architectures, similar principles can be applied to other systems. Therefore, although certain embodiments were described above by way of example with reference to certain exemplifying architectures for wireless networks, technologies and standards, embodiments may be applied to any other suitable forms of communication systems than those illustrated and described herein. It is also noted that different combinations of different embodiments are possible. It is also noted herein that while the above describes exemplifying embodiments of the invention, there are several variations and modifications which may be made to the disclosed solution without departing from the spirit and scope of the present invention.

1. A method comprising:
transmitting, by an apparatus, an indication of a plurality of resource elements for uplink transmissions of uplink control information and uplink data; and
receiving, by the apparatus, uplink control information on a portion of said plurality of resource elements, the portion being defined by a mapping operation,
wherein said mapping operation comprises:
partitioning the plurality of resource elements to define a predetermined number of frequency domain resource element sets; and
mapping the uplink control information to the plurality of resource elements in the predetermined number of frequency domain resource element sets to identify the portion of the plurality of resource elements.

2. A method comprising:
receiving, by an apparatus, an indication of a plurality of resource elements for uplink transmissions of uplink control information and uplink data; and
transmitting, by the apparatus, the uplink control information on a portion of said plurality of resource elements, said portion being identified via a mapping operation,
wherein said mapping operation comprises:
partitioning the plurality of resource elements to define a predetermined number of frequency domain resource element sets; and
mapping the uplink control information to the plurality of resource elements in the predetermined number of frequency domain resource element sets to identify the portion of the plurality of resource elements.

3. A method as claimed in claim 2, wherein said indication is a trigger message.

4. A method as claimed in claim 2, further comprising mapping uplink data transmissions around the uplink control information.

5. A method as claimed in claim 2, further comprising:
determining a number of resource elements required for transmitting the uplink control information in dependence on a power difference between a resource element assigned for uplink data transmission and a resource element assigned for uplink control information transmission.

6. A method as claimed in claim 1, further comprising transmitting an indication of a power difference between a resource element assigned for uplink data transmission and a resource element assigned for uplink control information transmission to the another apparatus.

7. A method as claimed in claim 1, further comprising receiving the uplink control information based on at least one of a cyclic-prefix orthogonal frequency division multiple access scheme and/or a discrete Fourier transform-spread-orthogonal frequency division multiple access scheme.

8. A method as claimed in claim 2, further comprising receiving an indication of a power difference between a resource element assigned for uplink data transmission and a resource element assigned for uplink control information transmission from another apparatus.

9. A method as claimed in claim 2, further comprising transmitting the uplink control information based on at least one of a cyclic-prefix orthogonal frequency division multiple access scheme and/or a discrete Fourier transform-spread-orthogonal frequency division multiple access scheme.

10. A method as claimed in claim 2, wherein said uplink control information comprises first and second types of uplink control information, wherein said mapping operation further comprises:
mapping the first type of uplink control information only to resource elements in a first frequency domain resource element set of the predetermined number of frequency domain resource element sets; and
mapping the second type of uplink control information only to resource elements in a second frequency domain resource element set of the predetermined number of frequency domain resource element sets.

11. A method as claimed in claim 2, wherein said uplink control information comprises first and second types of uplink control information, wherein said mapping operation further comprises:
mapping the first type of uplink control information only to resource elements in a first frequency domain resource element set of the predetermined number of frequency domain resource element sets; and
mapping some of the second type of uplink control information to resource elements in the first frequency domain resource element set and some of the second type of uplink control information to resource elements in a second frequency domain resource element set of the predetermined number of frequency domain resource element sets.

12. A method as claimed in claim 2, wherein said uplink control information comprises first and second types of uplink control information, wherein said mapping operation further comprises:
mapping some of the first type of uplink control information to a first frequency domain resource element set of the predetermined number of frequency domain resource element sets and some of the first type of uplink control information to a second frequency domain resource element set of the predetermined number of frequency domain resource element sets; and
mapping some of the second type of uplink control information to the first frequency domain resource element set and some of the second type of uplink control information to the second frequency domain resource element set.

13. A method as claimed in claim 2, wherein said plurality of resource elements are all located on an uplink shared channel.

14. A method as claimed in claim 2, further comprising determining the predetermined number of frequency domain resource element sets.

15. A method as claimed in claim 14, further comprising determining the predetermined number of frequency domain resource element sets in dependence of at least one of: current uplink transmission conditions, and/or radio channel characteristic and/or service type.

16. A method as claimed in claim 2, wherein said uplink control information comprises first and second types of uplink control information, the first type of uplink control information being more time critical than the second type of uplink control information and further comprising:
mapping said first and second types of uplink control information such that the first type of uplink control information is transmitted before the second type of uplink control information.

17. A method as claimed in claim 16, wherein the second type of uplink control information is transmitted in the last unit time period of a particular scheduling unit whilst the first type of uplink control information is transmitted in the earliest available unit time period of the scheduling unit.

18. A method as claimed in claim 16, wherein the first type of uplink control information is at least one of an acknowledgement feedback and/or a rank indicator and/or a beam index, and wherein the second type of uplink control information is at least one of a channel quality indicator and a precoding matrix indicator.

19. A method as claimed in claim 2, wherein said uplink control information comprises first and second types of uplink control information, the method further comprising:
mapping said first and second types of uplink control information into the predetermined number of frequency domain resource element sets independently of each other.

20. A method as claimed in claim 2, wherein said uplink control information comprises first and second types of uplink control information, the method further comprising:
jointly encoding the first and second types of uplink control information prior to performing any mapping information.

21. An apparatus comprising:
at least one processor; and
at least one memory comprising code that, when executed on said at least one processor, causes the apparatus to perform the method of claim 1.

22. An apparatus comprising:
at least one processor; and
at least one memory comprising code that, when executed on said at least one processor, causes the apparatus to perform the method of claim 2.

23. A computer program comprising computer code that, when executed on at least one processor, causes the method of claim 1 or any of to be performed.

24. A computer program comprising computer code that, when executed on at least one processor, causes the method of claim 2 to be performed.
